(19) United States
(12) Patent Application Publication
(10) Pub. No.: US 2002/0149502 A1
(43) Pub. Date: Oct. 17, 2002

(54) Event counter apparatus

(76) Inventor: Milton E. Goss, Beltsville, MD (US)

Correspondence Address: Benjamin Y Roca, The Johns Hopkins University, Applied Physics Laboratory, 11100 Johns Hopkins Road, Laurel, MD, 20723-6099, US

(21) Appl. No.: 10/089,716

(22) PCT Filed: Jul. 26, 2001
(86) PCT No.: PCT/US01/23708

(51) Int. Cl. H04Q 9/00; G08C 19/22

(52) U.S. Cl. 340/870.07; 340/870.16; 340/310.01; 340/310.08

(57) ABSTRACT

A device to be monitored plugs into the event counter apparatus which, in turn, plugs into a power source. The event counter apparatus monitors the flow of power from the power source, such as a wall outlet, to the device to be monitored. Each time the device to be monitored is powered on, current flows through the event counter apparatus. The current flow is detected and logged as an event. Event counter apparatus internal circuitry maintains a count of the number of times a device is powered on and off. The count is displayed on a display window of the event counter apparatus. The event counter apparatus may also include self-calibrating circuitry that stores a profile of the device's typical operating characteristics. The stored profile acts as a outside the fingerprint is detected an alarm can be activated to inform an observer to an anomalous status. In addition, RF circuitry may also be included to allow the event counter apparatus to forward its status and results to another device such as a computer, and to receive instructions from the other device.

### CROSS-REFERENCE TO RELATED APPLICATIONS

This application claims the benefit of prior filed co-pending U.S. Provisional Patent Application No. 60/222,457, filed on Aug. 2, 2000, and prior filed co-pending U.S. Provisional Patent Application No. 60/295,866, filed on Jun. 5, 2001.

### FIELD OF THE INVENTION

The present invention relates to an apparatus for detecting when, and how often, an electronic device is powered on and off

### BACKGROUND OF THE INVENTION

Monitoring an electronic device to determine when and how often power is cycled on and off can yield useful information. Knowing the number of times a sump pump activated, for instance, provides the owner with valuable information, such as how active water flow is under the house. Other diagnostic information can be extrapolated from such counts. Technicians could also use this information for troubleshooting equipment, or it could be used to monitor the activation of medical devices such as how many times a medication pump activated. This data can then be compared against expected results.

What is needed is an apparatus that can be passively attached between a power source and a device to be monitored that is capable of sensing when power is being supplied to the device and can display an iterative count to an observer each time the apparatus senses power to the device.

### SUMMARY OF THE INVENTION

A device to be monitored plugs into the event counter apparatus of the present invention. The event counter apparatus is designed so that any internal component failure will not stop power from flowing to the device being monitored. Standard 110 V/AC power is used to power an internal power supply which provides operating power for all the internal circuitry of the event counter apparatus. In addition, a battery backup can be included in case of commercial power failure.

The 110 V/AC power feeding the device to be monitored runs through a coil of wire in the event counter apparatus which detects current flow. The current detection circuitry can also include a sensitivity adjustment which configures the event counter apparatus to operate according to the current draw of the specific device being monitored. Current detection circuitry converts current flow into a single pulse which is then counted and incremented by counter circuitry and displayed on a digital display. The display provides an observer with a readout of the number of times the device has been powered on and off. The event counter apparatus can be expanded to allow remote turn-off of the device being monitored, and power cycling after a certain number of counts. A battery backup assures that count and display information is retained in case of commercial power failure.

### BRIEF DESCRIPTION OF THE DRAWINGS

FIG. 1 illustrates a perspective front view of the event counter apparatus.

FIG. 2 illustrates a perspective rear view of the event counter apparatus.

FIG. 3 illustrates a first circuit schematic of the event counter apparatus components.

FIG. 4 illustrates a second circuit schematic of the event counter apparatus components.

### DESCRIPTION OF THE PREFERRED EMBODIMENTS

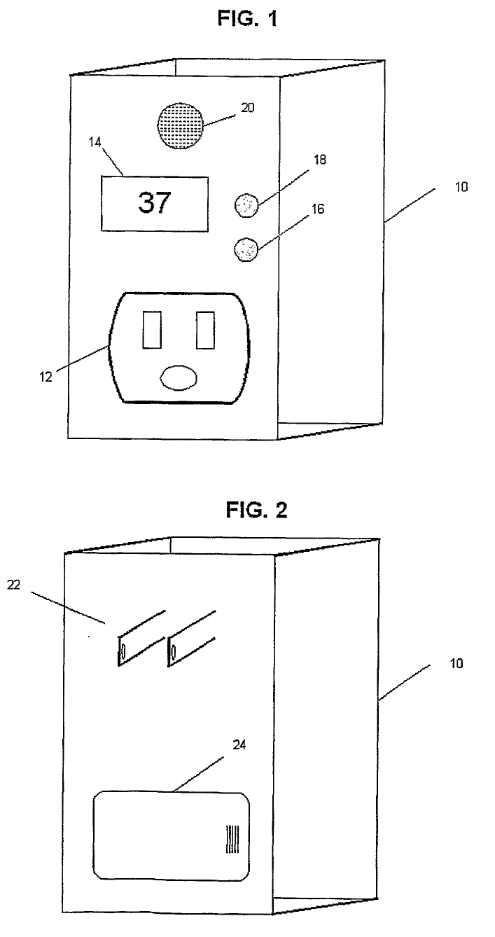

FIG. 1 illustrates a perspective front view of the event counter apparatus. The apparatus 10 is a relatively small unit approximately the size of a electrical socket wall plate and having a depth of approximately two inches. On its front surface there is a standard electrical jack 12, a display 14, a reset button 16, a calibration button 18, and an alarm 20. The electrical jack 12 is for receiving the male end of the power cord for the device to be monitored. The display 14 is for displaying the current count pertaining to the number of times the device being monitored has been powered on and off since the last reset of the event counter. The reset button 16 is for resetting the counter to zero so that a new count can be initiated. The calibration button 18 is for tailoring the sensitivity of the event counter apparatus 10 to the device being monitored. The alarm 20 is for notifying an observer when abnormal activity within the device being monitored is detected.

FIG. 2 illustrates a rear perspective view of the event counter apparatus 10 shown in FIG. 1. The apparatus 10 further includes, on its back surface, male prongs 22 for coupling with a standard electrical jack and a battery access door 24. Once apparatus 10 is coupled to a live electrical jack and a device to be monitored is coupled to apparatus 10, then power can be passed from the live electrical jack through apparatus 10 into the device to be monitored. When the device to be monitored is turned on, power flows through the event counter apparatus 10 into the device to be monitored. The flow of power is an event that is detected by apparatus 10.

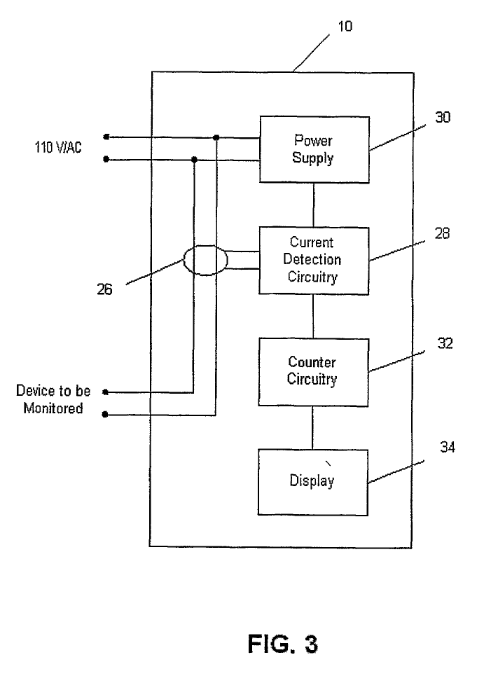

FIG. 3 illustrates a first circuit schematic of the event counter apparatus 10 components. Event counter apparatus 10 passively monitors the flow of current to a device being monitored via a current pick-up loop 26. The current pick-up loop 26 is coupled with current detection circuitry 28 that converts current flow into a pulse which is then forwarded to counter circuitry 32 that keeps a running count of the number of pulses it receives. Current detection circuitry 28 is electrically connected to a power source 30 and a display 34. A power source 30 provides the power necessary to operate the apparatus. The power for power source 30 can be obtained from the connection to the electrical jack or can be supplied via a battery, or by both with the battery acting as a back-up power supply should power be lost to the electrical jack. Display 34 is electrically connected to counter circuitry 32 and provides updated counts reflecting the number of times that the device to be monitored has been powered up and down. The counter circuitry 32 is also responsive to the reset button such that when the reset button is depressed the counter resets itself to zero and begins a new count.

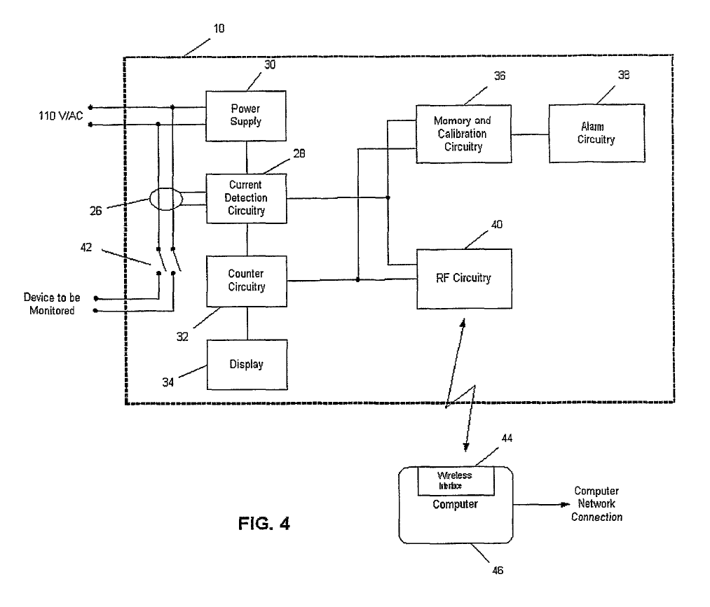

FIG. 4 includes all of the same components of the event counter apparatus shown in FIG. 3 plus some additional components. The additional components include memory and calibration circuitry 36, alarm circuitry 38, RF circuitry 40, and a switch 42.

The memory and calibration circuitry 36 is coupled with the current detection circuitry 28 and the counter circuitry 32. The memory and calibration circuitry 36 includes smart software to allow the counter to be “self-calibrating.” The event counter apparatus 10 is designed to “learn” over a period of time the operating characteristics of a device being monitored, and to compare subsequent device actuation to this “learned” pattern. For example, an event counter apparatus 10 with a self-calibrating feature could be hooked up to a commercial freezer where compressor failure could result in the loss of large amounts of food. The event counter apparatus 10, via the memory and calibration circuitry 36, would then calibrate itself based on the freezer compressor characteristics and actuation patterns it has learned. The event counter apparatus 10 might learn, for instance, that a freezer's compressor runs quite a bit more during the day. Subsequently, an internal alarm would activate if the event counter apparatus 10 detected an abnormal pattern, thereby giving advance notice to a potential compressor failure.

The memory and calibration circuitry 36 uses a combination of software and programmable hardware (PROMs) to monitor and store the turn-on and current characteristics of a device being monitored. The information is received from the current detection circuitry 28 and the counter circuitry 32 and is kept in memory and used as a “fingerprint” to compare against future device operation. Operation out of the fingerprint range would trigger an alarm, notifying an observer to check the device being monitored for a potential failure.

The alarm circuitry 38 is coupled with the memory and calibration circuitry 36. When am event is detected outside of the fingerprint range previously calibrated, a signal is sent to the alarm circuitry 38 which causes a visual and/or audible alarm to emanate from the event counter apparatus 10. The alarm is designed to warn an observer to a potential or actual malfunction in the device being monitored.

The RF circuitry 40 is for communicating data pertaining to the device being monitored, including alarms, to a nearby wireless interface 44 that is typically coupled with a computer 46. The RF circuitry can also receive data from the wireless link 44 making it a two-way communication device. Computer 46 can also be connected to the Internet or other computer network. If a network connection is available, then a user can remotely monitor a device and respond to abnormal activity. For instance, a user could determine that a device being monitored by an event counter apparatus 10 is malfunctioning and could remotely power down, via switch 42, the device being monitored to avoid further damage. The user could also remotely set calibration points or reset event counters, or activate other features.

There are numerous suitable RF links that could be applied to the present invention that one of ordinary skill in the art could readily choose from. One particularly suitable RF link is the Bluetooth™ RF standard.

While the description above has referenced standard 110 V/AC, one of ordinary skill in the art could readily adapt the present invention to operate with different power supply ratings without departing from the spirit or scope of the present invention. For instance, another power rating or plug configuration could be substituted in order to operate the device in a foreign country having different standard power specifications.

In the following claims, any means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. An event counter apparatus for monitoring an electrical device, comprising:
a current loop that passively detects the presence of current intended for said electrical device;
current detection circuitry coupled with said current loop that converts the presence of current into a pulse;
counter circuitry coupled with said current detection circuitry that increments and maintains a count of said pulses; and
a display coupled with said counter circuitry that displays the current count of pulses.

2. The event counter apparatus of claim 1 further comprising a reset button that causes the counter to reset to zero.

3. The event counter apparatus of claim 1 further comprising memory and calibration circuitry that stores data pertaining to the normal operating characteristics of the electrical device being monitored, and calibrates the event counter apparatus to reflect the normal operating characteristics of the electrical device being monitored.

4. The event counter apparatus of claim 3 further comprising alarm circuitry that signals an alarm when current is detected outside of the normal operating characteristics of the electrical device being monitored.

5. The event counter apparatus of claim 4 further comprising RF circuitry that transmits count data and alarm data pertaining to the status of the device being monitored.

6. The event counter apparatus of claim 5 wherein said RF circuitry receives control signals that cause the event counter apparatus to act in response to said alarm data and/or said count data.

7. The event counter apparatus of claim 1 wherein said current loop, current detection circuitry, counter circuitry, and display are housed within a housing wherein said housing comprises an electrical jack for receiving the power cord of an electrical device, and male prongs for electrically coupling the event counter apparatus to an electrical jack.

8. The event counter apparatus of claim 5 wherein said current loop, current detection circuitry, counter circuitry, display, memory and calibration circuitry, alarm circuitry, and RF circuitry are housed within a housing wherein said housing comprises an electrical jack for receiving the power cord of an electrical device, and male prongs for electrically coupling the event counter apparatus to an electrical jack.

9. A method of monitoring an electrical device, comprising:
detecting whether electrical current is flowing from a power source to the electrical device to be monitored indicating that the electrical device has been powered on;
if there is current flowing, then converting the presence of current into a pulse;
keeping a running count of the number of pulses; and
displaying the current count indicating the number of times the electrical device has been powered on since the counter was last reset.

10. The method of claim 9 further comprising storing data pertaining to the normal operating characteristics of the electrical device being monitored; and triggering an alarm when data outside of the normal operating characteristics of the electrical device being monitored is detected.

11. The method of claim 10 further comprising transmitting count data and alarm data pertaining to the status of the device being monitored.
